(19) United States
(12) Patent Application Publication
(10) Pub. No.: US 2009/0189102 A1
(43) Pub. Date: Jul. 30, 2009

(54) Valve Assemblies and Parts Therefor

(75) Inventor: Sean John Linden, Birmingham (GB)

Correspondence Address: BUCHANAN, INGERSOLL & ROONEY PC, POST OFFICE BOX 1404, ALEXANDRIA, VA, 22313-1404, US

(73) Assignee: THE LINDEN SHIELD LIMITED, Birmingham (GB)

(21) Appl. No.: 11/886,686

(22) PCT Filed: Mar. 20, 2006
(86) PCT No.: PCT/GB2006/001026

§ 371 Date: Feb. 11, 2009

(30) Foreign Application Priority Data
Mar. 19, 2005 (GB) 0505733.6

(51) Int. Cl. F16K 31/02

(52) U.S. Cl. 251/129.01

(57) ABSTRACT

The present invention relates to valve assemblies. In one embodiment of the invention, a temperature-sensitive safety valve assembly comprises a first region which contains a first pressurised fluid, and a second region which contains a second pressurised fluid. The second region comprises a heat-sensitive sealing means. A valve is arranged between the first and second regions. In a first configuration, the pressure of the second pressurised fluid in the second region overcomes the pressure of the first pressurised fluid to actuate the valve to open the first outlet. The heat-sensitive sealing means in the second region is, in a second configuration, arranged to fail at high temperature so as to de-pressurise the second region, thereby actuating the valve to move under the first pressurised fluid in the first region so as to close the first outlet and seal the first region. Other improvements to valve assemblies arc also disclosed.

The present invention relates to a valve assemblies and parts therefor.

It is known from International Patent Application No. PCT/GB02/04981 (in the name of the Applicant) to provide a temperature-sensitive safety valve assembly which shuts off a gas supply pipe at high temperature. The temperature-sensitive safety valve assembly comprises a first pipe, a second pipe and a valve between the two pipes. The first pipe is arranged to contain a first, above-atmospheric-pressure, pressurised fluid such as natural gas. The second pipe is arranged to contain a second, higher pressure, fluid such as air. The valve is opened by the pressure of the air in the second pipe acting against a spring. The second pipe has a fluid-filled glass bulb which is fitted into the end of the second pipe to seal the second pipe from the atmosphere. The fluid in the fluid-filled glass bulb boils at high temperature. When the fluid boils, the bulb shatters leaving an open end to the second pipe, which allows escape of air and de-pressurisation of the second pipe. The spring then cause the valve to slide into the second pipe and close the first pipe, thereby stopping the flow of natural gas from the first pipe.

One aim of the present invention is to provide a simplified temperature sensitive safety valve assembly.

According to a first aspect of the invention there is provided a temperature-sensitive safety valve assembly comprising a first region which contains a first pressurised fluid, a second region which contains a second pressurised fluid, the second region comprising a heat-sensitive sealing means, a valve between the first and second regions, wherein in a first configuration the pressure of the second pressurised fluid in the second region overcomes the pressure of the first pressurised fluid to actuate the valve to open the first outlet, and the heat-sensitive sealing means in the second region is, in a second configuration, arranged to fail at high temperature so as to de-pressurise the second region, thereby actuating the valve to move under the first pressurised fluid in the first region so as to close the first outlet and seal the first region.

Another aim of the invention is to improve the detection of leaks along the length of a pipe.

According to a second aspect of the invention there is provided a valve assembly comprising a first region for containing a first fluid, a second region for containing a second fluid, and a valve therebetween, and a third region for containing a third pressurised fluid, the first region being in fluid communication with the second region when the valve is open, the first region not being in fluid communication with the second region when the valve is closed, wherein the third region passes through a wall of the second region, and the third region runs along at least part of the inside of the second region.

According to a third aspect of the invention there is provided a valve assembly comprising a first region for containing a first fluid, a second region for containing a second fluid, and a valve therebetween, and a third region for containing a third pressurised fluid, the first region being in fluid communication with the second region when the valve is open, the first region not being in fluid communication with the second region when the valve is closed, wherein the third region passes through a wall of the first region, and the third region runs along at least part of the inside of the first region.

According to a fourth aspect of the invention there is provided a valve assembly comprising a first region for containing a first fluid, a second region for containing a second fluid, and a valve therebetween, and a third region for containing a third pressurised fluid, the first region being in fluid communication with the second region when the valve is open, the first region not being in fluid communication with the second region when the valve is closed, wherein the third region surrounds a wall of the second region, and the third region runs along at least part of the outside of the second region.

According to a fifth aspect of the invention there is provided a valve assembly comprising a first region for containing a first fluid, a second region for containing a second fluid, and a valve therebetween, and a third region for containing a third pressurised fluid, the first region being in fluid communication with the second region when the valve is open, the first region not being in fluid communication with the second region when the valve is closed, wherein the third region surrounds a wall of the first region, and the third region runs along at least part of the outside of the first region.

The first region may be connected to the first or second region by a pipe or pipes.

The pipe or pipes may run substantially along the entire length of the first or second region. Pipes may run substantially along the entire length of the first and second regions.

The pipe or pipes may run along the middle of the first or second region.

The pipe or pipes may comprise a flexible part, and may take the form of a flexible hose.

Preferably, the valve assembly of the first, second, third, or fourth aspects of the invention is a temperature sensitive safety valve assembly.

Another aim is to stop the heat sensitive sealing means triggering the valve assembly unnecessarily.

According to a sixth aspect of the invention there is provided a temperature sensitive safety valve assembly comprising a heat sensitive sealing means, and a combustible buffer arranged at least partially around the heat sensitive sealing means, the combustible buffer tolerating a certain amount of heat exposure before failing so that the heat sensitive sealing means can then be triggered.

Preferably the heat sensitive sealing means is made of foam. The heat sensitive sealing means may be fully surrounded by the buffer.

Preferably, the temperature-sensitive safety valve assembly comprises a first region for containing a first pressurised fluid, the first region having a first outlet, a second region for containing a second pressurised fluid, the second region comprising a heat-sensitive sealing means, a valve between the first and second regions, the first outlet being biased closed by biasing means, the valve being arranged to be actuated by the pressure of a second pressurised fluid in the second region overcoming the biasing means, to open the first outlet, wherein the heat-sensitive sealing means in the second region fails at high temperature so as to de-pressurise the second region, thereby actuating the valve to move under the biasing means to close the first outlet and seal the first region, the heat-sensitive sealing means having a polystyrene foam part at least partially surrounding it.

The valve assembly is preferably fitted to a fuel line.

The foam housing provides a certain delay time, which is useful when exposed to transient eruptions of flames occurring in the said use.

According to a seventh aspect of the invention there is provided a valve assembly for opening or closing a fluid line, the valve assembly comprising a movable valve, wherein movement of the valve causes an electrical signal.

The valve assembly is preferably a temperature-sensitive safety valve assembly, most preferably for a fuel line such as a gas supply line.

The valve preferably comprises a magnet, movement of the valve with respect to a reed switch on the valve assembly causes initiation of a reed switch and an electrical signal.

Most preferably the valve comprises a plunger on a rod, the rod carries the magnet. Preferably, the magnet is arranged at one end of the valve, most preferably at a lower end. In this way, the co-operating part of the switch can be arranged adjacent the magnet.

Alternatively, the valve may comprise a reed switch, and movement of the valve with respect to a magnet on the valve assembly causes initiation of a reed switch and an electrical signal.

According to an eighth aspect of the invention there is provided a fossil fuel fired cooker assembly comprising a temperature-sensitive safety valve assembly which shuts of the fuel supply at a certain temperature, the temperature-sensitive safety valve assembly comprises a first region for a first pressurised fluid, a second region for a second pressurised fluid, the second region comprising a heat-sensitive sealing means, a valve between the first and second regions, biasing means biasing the first region closed, the valve being arranged to be actuated by the pressure of a second pressurised fluid in the second region overcoming the biasing means to open the first region, wherein the heat-sensitive sealing means in the second region is arranged to fail at high temperature so as to de-pressurise the second region, thereby actuating the valve to move under the biasing means to close the first first region.

Preferably, the heat-sensitive sealing means is fitted in a hood of the cooker assembly.

The cooker assembly preferably comprises a fire extinguishing agent in fluid communication with the second region, and once the predetermined temperature is exceeded, agent is released.

According to a ninth aspect of the invention there is provided a temperature sensitive safety valve assembly comprising a first region for a first pressurised fluid, the region having a first outlet, a second region for a second pressurised fluid, the second region comprising a heat-sensitive sealing means, a valve between the first and second regions, biasing means biasing the first region closed, a valve adapted to be actuated by the pressure of a second pressurised fluid in the second region against biasing means to open the outlet, wherein the safety valve assembly comprises a sensor unit, which is arranged to sense fat in the atmosphere, and react to the sensing of the fat by sealing the first region.

According to a tenth aspect of the invention there is provided a temperature sensitive safety valve assembly for a fuel supply line comprising a first region containing a first pressurised fluid, the first region having a first outlet, a second region containing a second pressurised fluid, the second region comprising a heat-sensitive sealing means, a valve between the first and second regions, biasing means biasing the first outlet closed, the valve being arranged to be actuated by the pressure of a second pressurised fluid in the second region overcoming the biasing means to open the first outlet, wherein the heat-sensitive sealing means in the second region fails at high temperature so as to de-pressurise the second region, thereby actuating the valve to move under the biasing means to close the first outlet and seal the first region, wherein the parts forming the first and second regions are moulded or cast from a single piece of material.

According to an eleventh aspect of the invention there is provided a temperature-sensitive safety valve assembly comprising a first region for a first pressurised fluid, the first region having a first outlet, a second region for a second pressurised fluid, the second region comprising a heat-sensitive sealing means, a valve between the first and second regions, biasing means biasing the first outlet closed, the valve being arranged to be actuated by the pressure of a second pressurised fluid in the second region overcoming the biasing means to open the first outlet, wherein the heat-sensitive sealing means in the second region fails at high temperature so as to de-pressurise the second region, thereby actuating the valve to move under the biasing means to close the first outlet and seal the first region, and the assembly comprising a housing and a lever which is pivotably attached to the housing, the lever also being attached to the valve, so that when the lever is moved the valve is moved.

The housing may define an aperture and the lever may define an aperture, which can move to coincide. Preferably, the assembly comprises a pin which can be removably installed in the housing and lever apertures. The pin may have a handle, preferably oversized. The pin may be attached to the housing by a chain or the like.

According to a twelfth aspect of the invention there is provided a valve assembly for a fluid line, wherein the valve assembly comprises a first region for a first pressurised fluid, a second region for a second pressurised fluid, and a valve between the first and second regions, a receiver unit for receiving a remote, wireless, signal, and a motor driven ball or gate valve which, upon receipt of the remote, wireless, signal, is powered to operate the valve.

Preferably, the valve assembly is installed on a water supply line.

Preferably, the ball or gate valve is driven by a geared motor, the gearing ratio may be more than 10:1, preferably more than 50:1, optimally about 60:1. In this way, a low powered motor can provide sufficient force to operate the valve. The ball or gate valve may alternatively be driven by a variable powered motor.

Preferably, the valve housing defining the first region and second region is moulded or cast.

Preferably, a telemetry unit is fitted to the valve assembly. The unit may define an aperture which allows the unit to be slid onto a pipe.

According to a thirteenth aspect of the invention there is provided a vehicle such as a mobile home or sea craft such as a boat comprising a valve assembly in accordance with any of the other aspects of the invention.

According to a fourteenth aspect of the invention there is provided a high pressure fluid line comprising a valve assembly, the valve assembly comprising a housing and a ball or gate valve, the housing defining a recess, wherein when the ball or gate valve is actuated the ball or gate valve moves into the recess and substantially out of the flow path of fluid in the line.

According to a fifteenth aspect of the invention there is provided a valve assembly for a fluid line, wherein the valve assembly comprises a biometrics recognition unit such as a fingerprint recognition unit to prevent tampering.

Preferably, the valve assembly comprises a suction unit which can trap a hand of a person so as to prevent tampering.

According to a sixteenth aspect of the invention there is provided a safety valve assembly comprising a first region for a first pressurised fluid, the region having a first outlet, a second region for a second pressurised fluid, a valve between the first and second regions, wherein the safety valve assembly is remotely, wirelessly, electronically operable, and the valve assembly is arranged to be at least partially powered by flow through the valve.

Preferably, the valve assembly is installed on a water or fuel supply line.

Safety valve assemblies in accordance with the invention will now be described by way of example only and with reference to the drawings in which:-

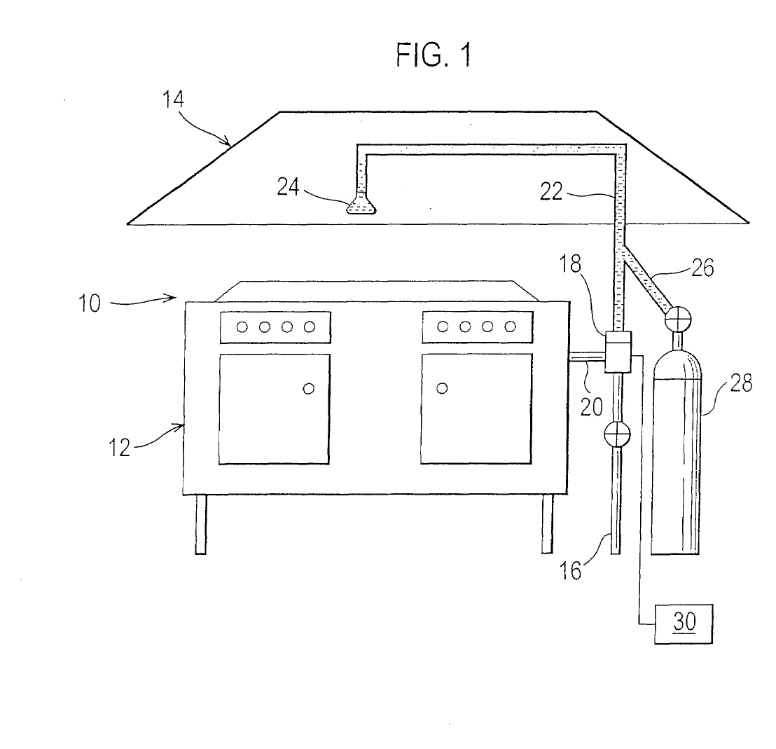

FIG. 1 is a simple schematic view of a cooker assembly in accordance with the invention,

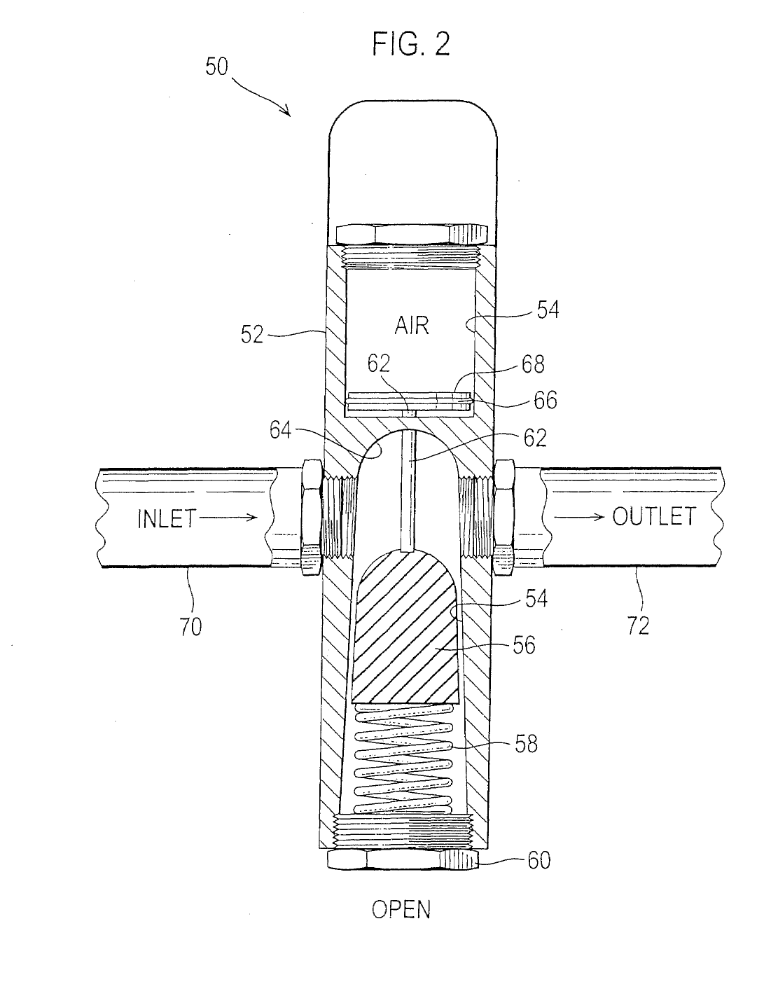

FIG. 2 is a simple schematic frontal view, partly cutaway, of a temperature-sensitive safety valve assembly in accordance with the invention, in an open configuration when the air region is sealed,

FIG. 2 is the valve assembly of FIG. 2 in a closed configuration,

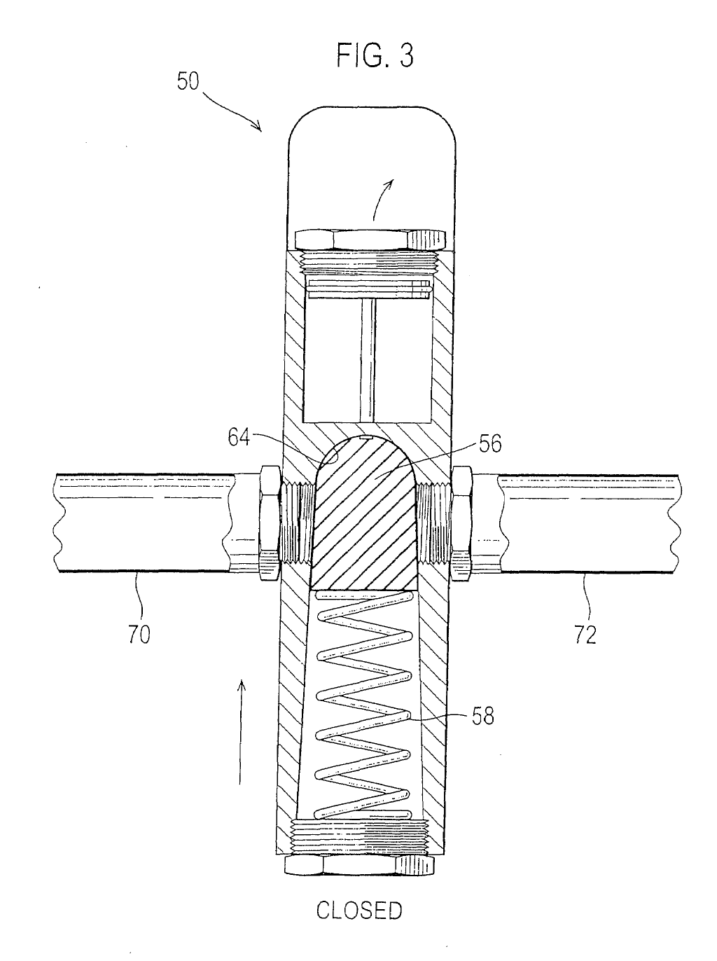

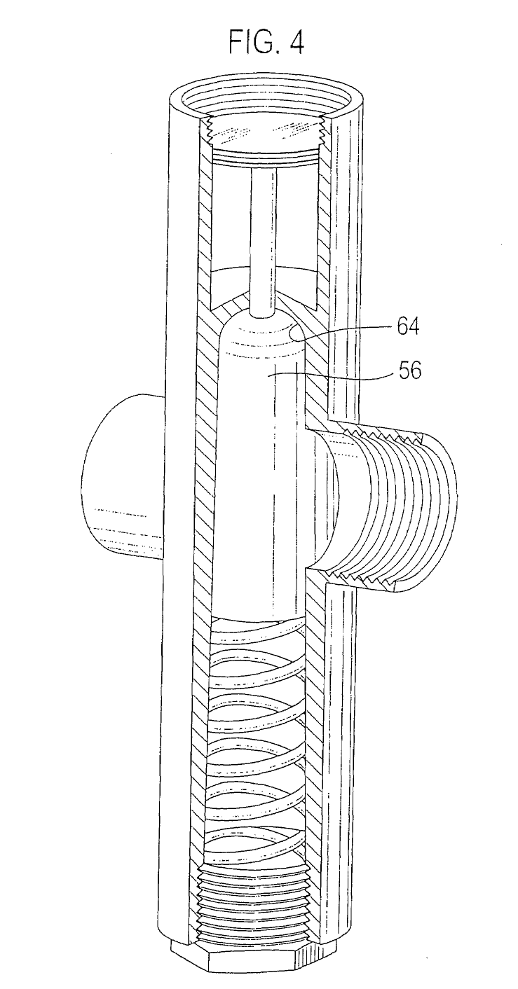

FIG. 4 is a perspective view, partly cutaway, of a valve assembly like the valve assembly of FIGS. 2 and 3,

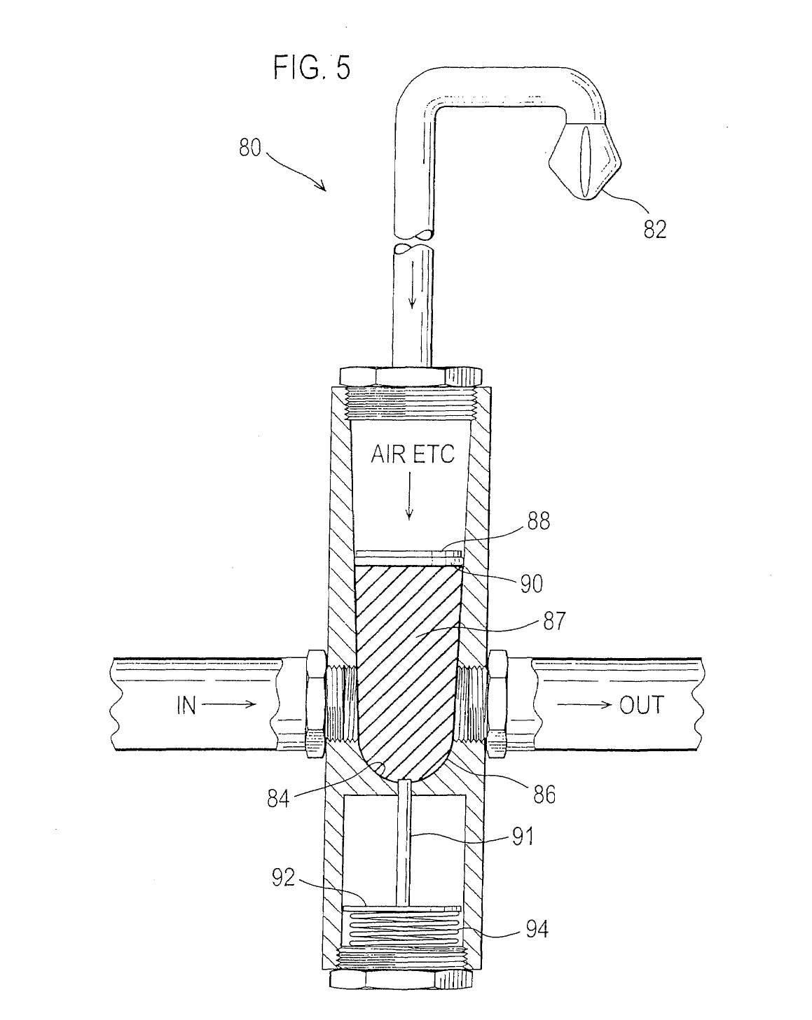

FIG. 5 is a temperature-sensitive safety valve assembly arranged to be in an open configuration when the air region is sealed,

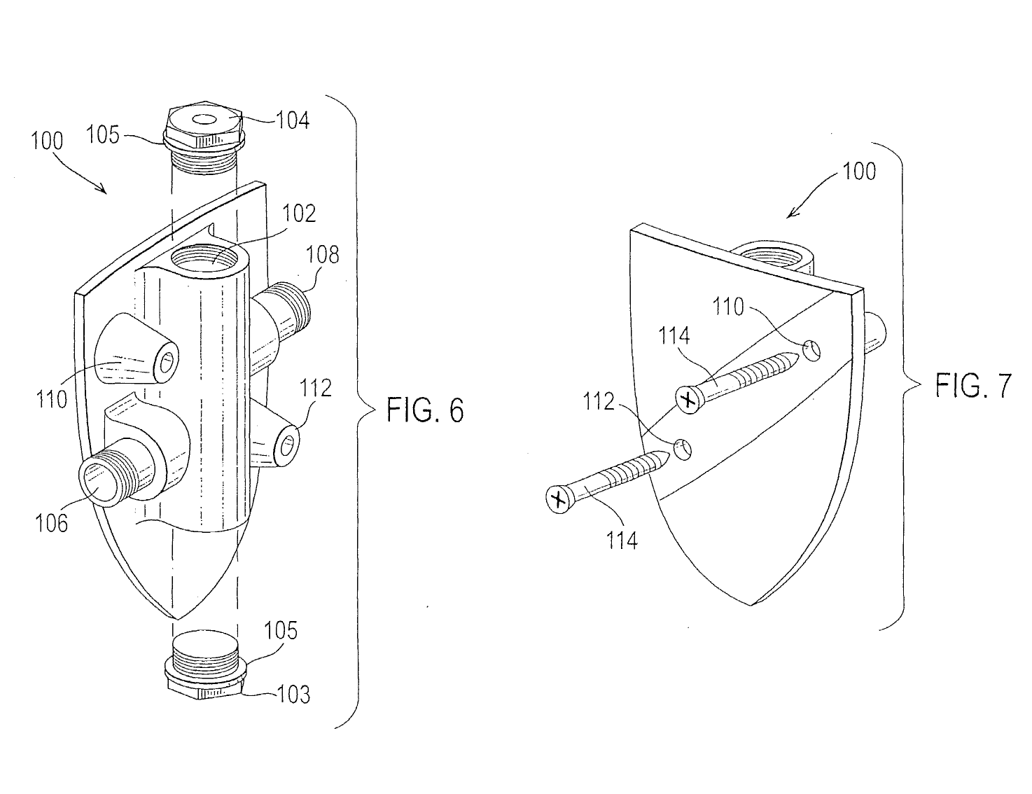

FIGS. 6, 7, 8 and 9 are, respectively, a rear perspective view, a front perspective view, an exploded view of the internal components and a rear perspective view, partly in cutaway, of a moulded temperature-sensitive safety valve assembly in accordance with the invention,

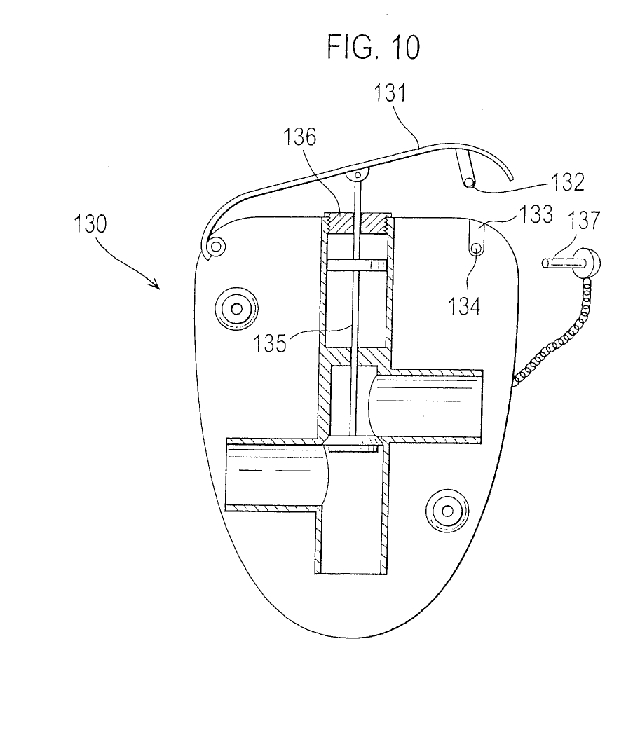

FIG. 10 is another type of moulded temperature-sensitive safety valve assembly in accordance with the invention,

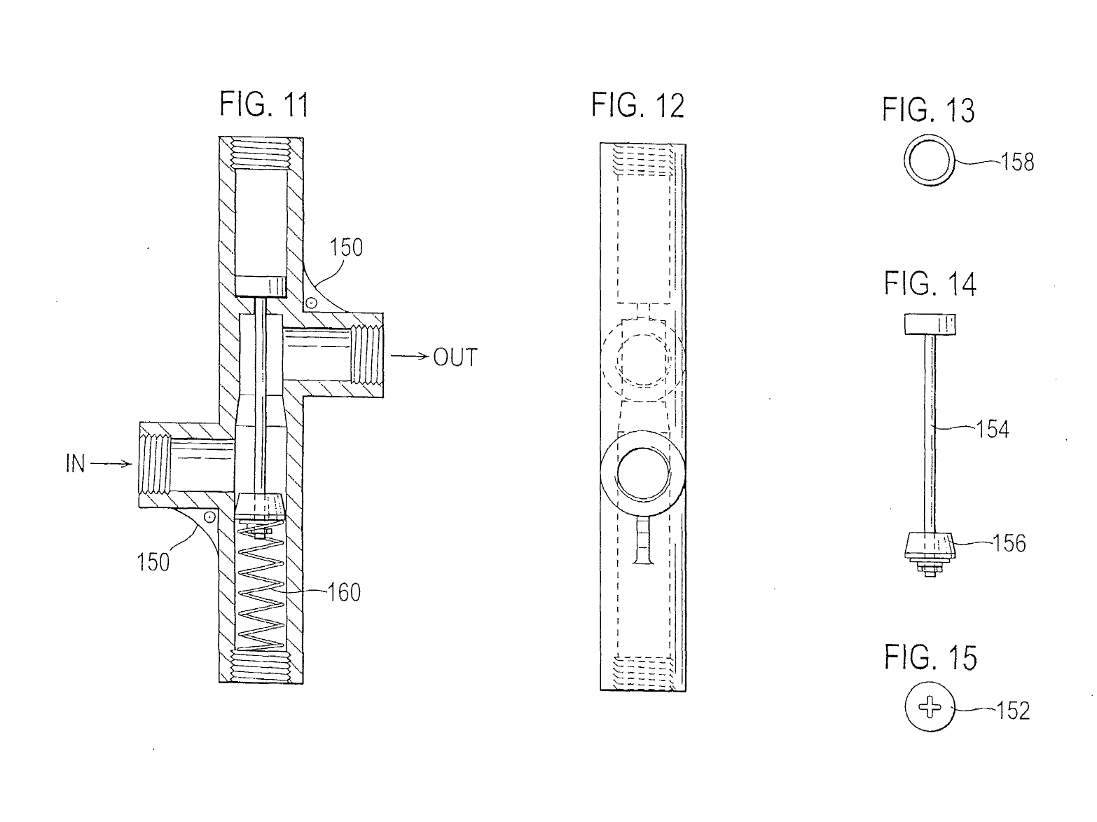

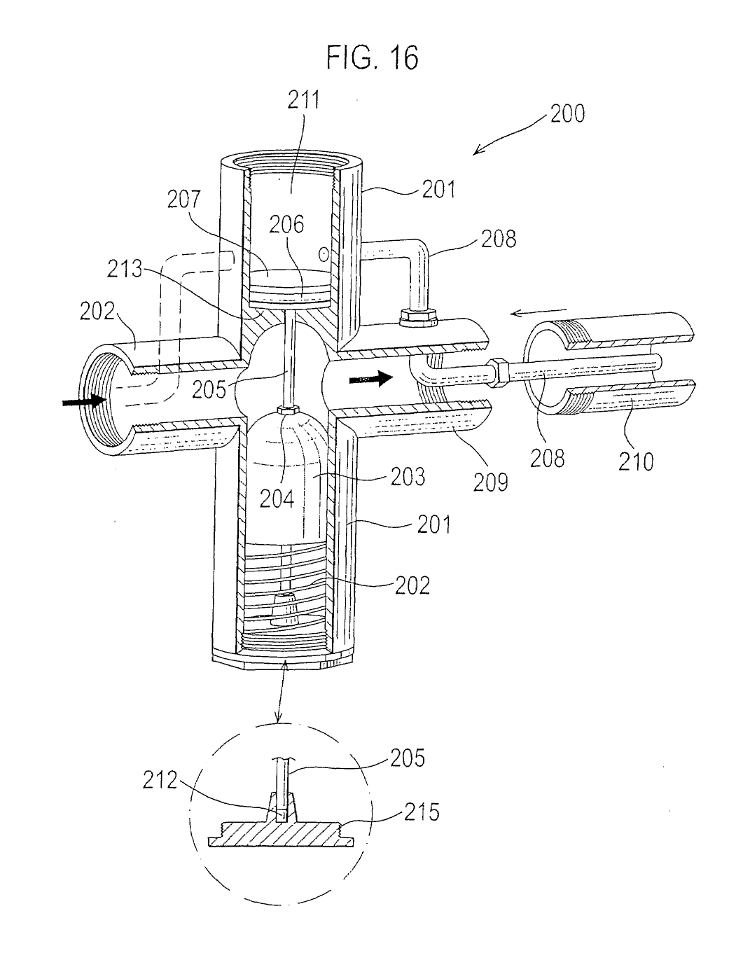

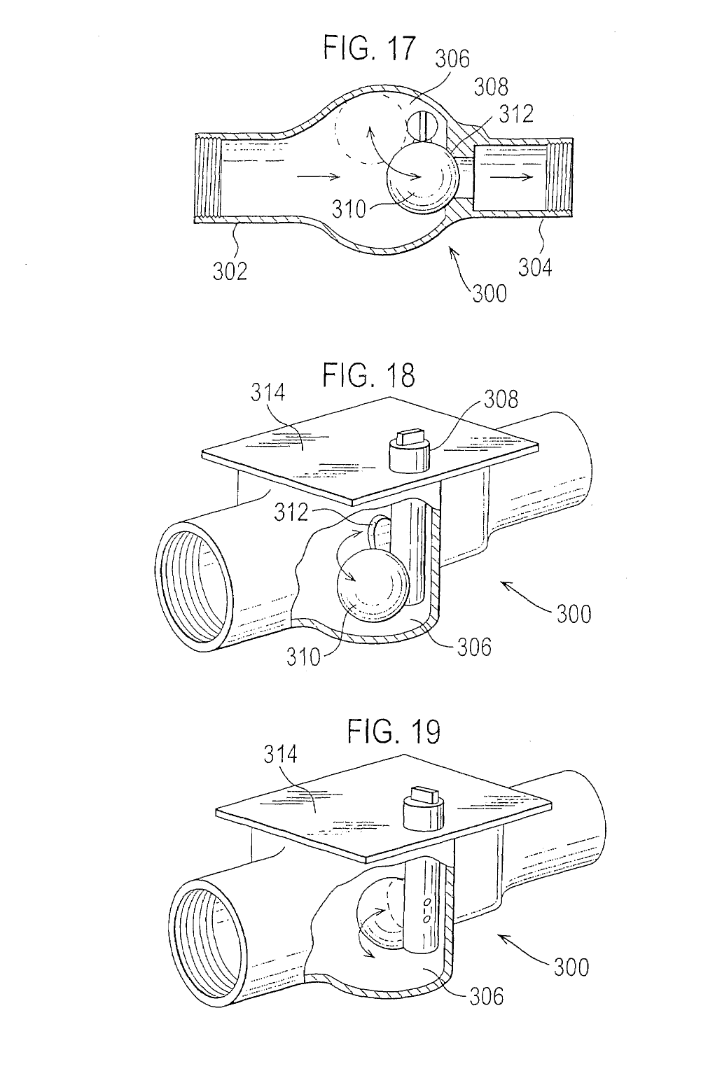

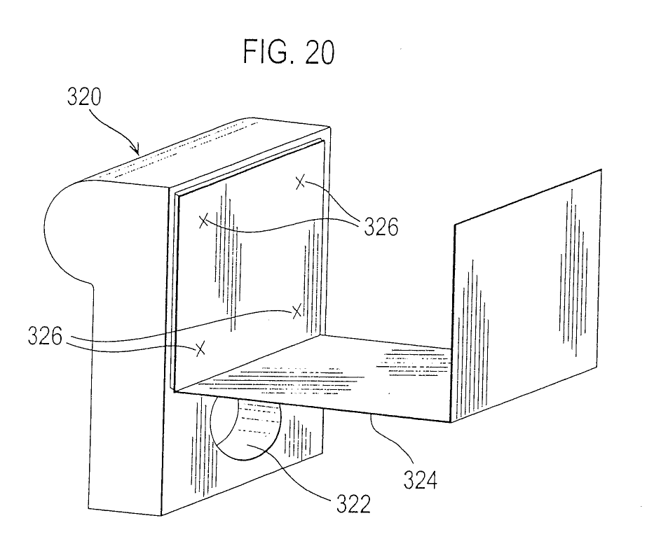

FIGS. 11 to 20 are parts of another type of a moulded temperature-sensitive safety valve assembly in accordance with the invention,

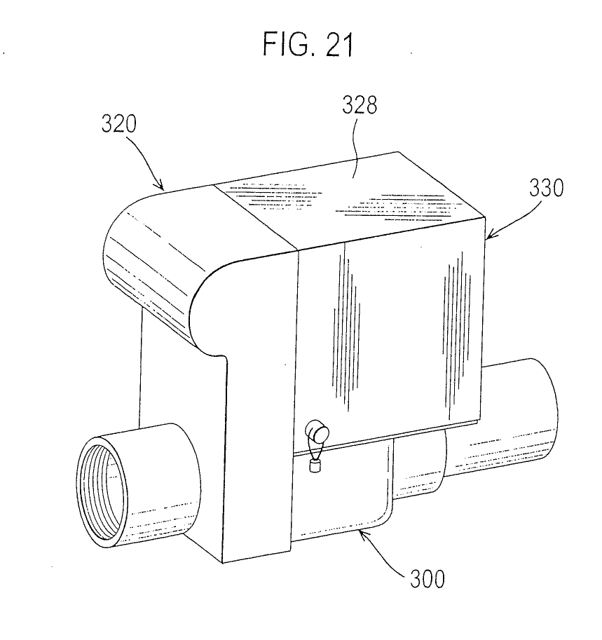

FIG. 21 is a perspective view, partly in cutaway, of a temperature-sensitive safety valve assembly with a parallel feed pipe in accordance with the invention,

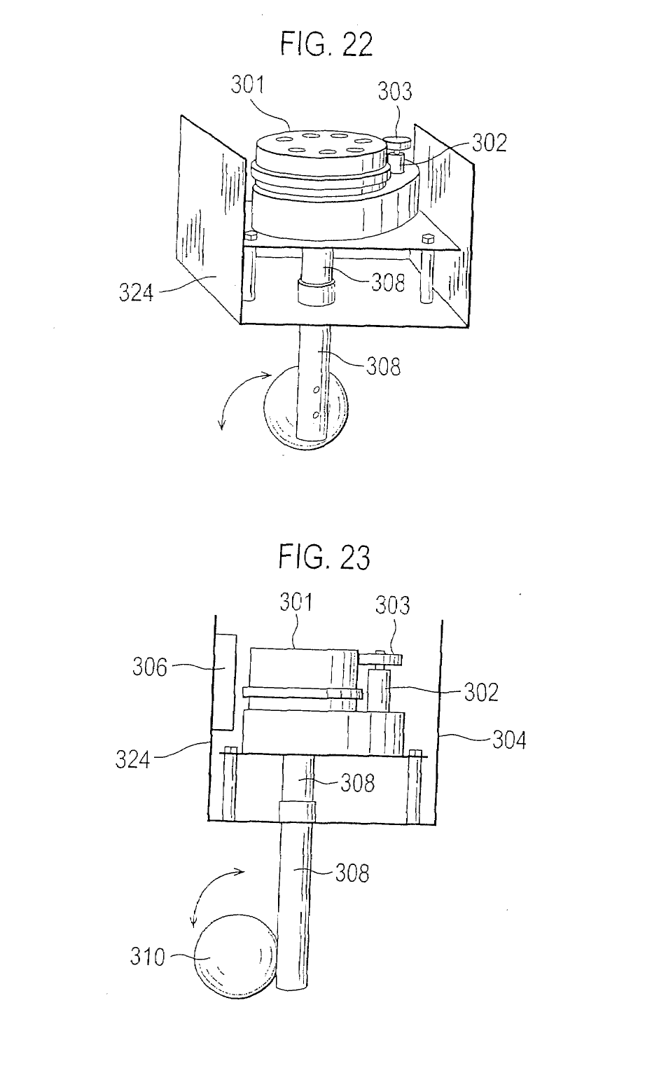

FIG. 22 is a bottom view of part of a valve control assembly in accordance with the invention showing hidden detail operation of valve,

FIG. 23 is a schematic perspective view of the valve of FIG. 22 again showing hidden detail, in an open configuration,

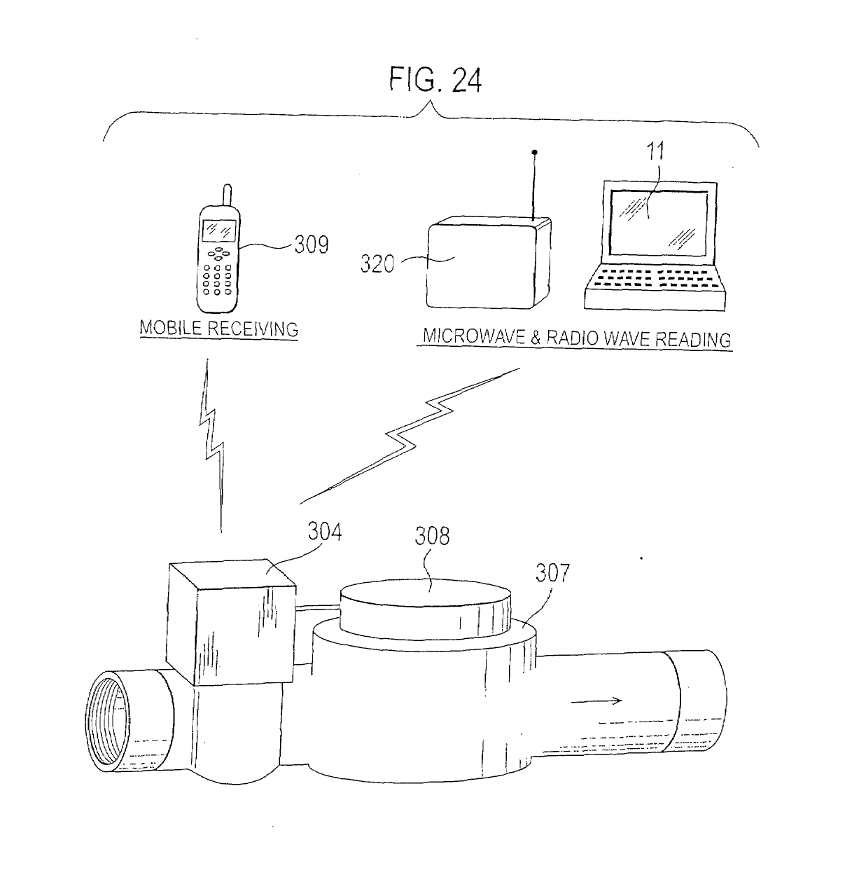

FIG. 24 is schematic perspective view of the valve of FIG. 22 again showing hidden detail, in a closed configuration,

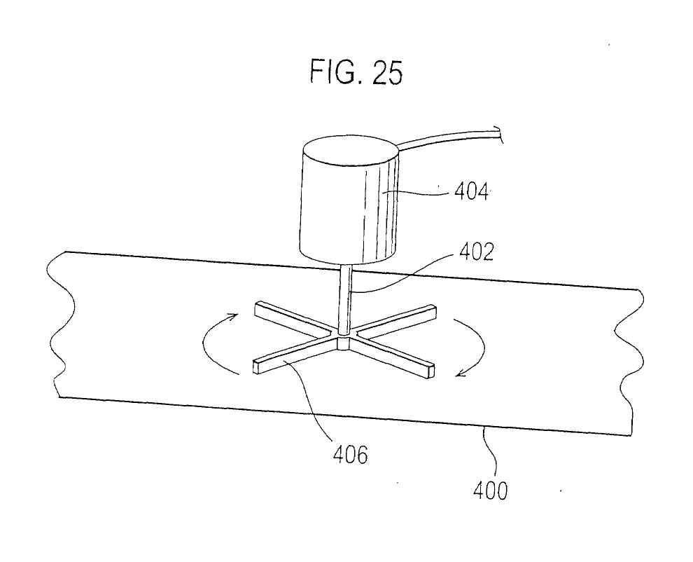

FIG. 25 is perspective view of part of a valve control assembly,

FIG. 26 is a perspective view of the assembled valve control assembly,

FIG. 27 is a cutaway perspective view showing the parts inside the valve control assembly,

FIG. 28 is a cutaway side view showing the parts inside the valve control assembly,

FIG. 29 is a perspective view showing a valve control assembly in use, along with a metering device, and

FIG. 30 is a side view of power supply for control valve in accordance with the invention.

Referring to FIG. 1, a cooker assembly 10 in accordance with the invention comprises a cooker 12 and a canopy 14 above it.

The cooker assembly 10 has a first pipe 16 and a second pipe 20 for supplying a flammable gas to the cooker 12, and a temperature-sensitive safety valve assembly 18 arranged between the first pipe and the second pipe.

The cooker assembly 10 has a third pipe 22 which extends from, the temperature-sensitive safety valve assembly 18. The third pipe 22 is closed at its free end by a fluid filled glass bulb 24, thereby sealing the third pipe 22 from the atmosphere. The fluid filled glass bulb 24 is advantageously arranged in the canopy 14. The third pipe 22 is for a second pressurised fluid such as air.

At a convenient point along the length of the third pipe 22 there is a junction at which a fourth pipe 26 extends from the third pipe. The fourth pipe 26 is in fluid communication with a fire extinguishing agent in a canister.

The temperature-sensitive safety valve assembly 18 operates as follows:

The pressure of the pressurised air in the third pipe 22 acts against a spring or other biasing means (not shown for conciseness), causing the valve to open. The open valve allows fluid to flow from the first pipe 16 to the second pipe 20.

In the event of a chip pan fire or the like, the fluid filled glass bulb 24 can be exposed to high temperature and possibly naked flames. The fluid filled glass bulb 24 on the third pipe 22 shatters at high temperature so as to allow escape of the pressurised air and de-pressurisation of the third pipe 22. The de-pressurisation of the third pipe 22 allows the valve to move, under the biasing means, to stop the supply of natural gas from the first pipe 16 to the second pipe 20.

When the fluid filled glass bulb 24 bursts, the fourth pipe 26 is also de-pressurised. thereby simultaneously activating the flow of a wet chemical extinguishing agent from the extinguisher 28, allowing the agent to douse the fire through the orifice which remains at the failed fluid filled glass bulb 24.

Also shown in FIG. 1 is a fat sensor 30 which senses fat in the atmosphere. When too much fat is sensed a signal is sent to the valve assembly 18 to shut off the cooker.

Referring to FIG. 2, a valve assembly 50 comprises a body 52, made of PVC, brass or aluminium, and which defines a chamber 54. A rubber bung 56 is arrange din the chamber 54. An upper end of the bung is convex. A spring 58 sits between the bung 56 and a closure plug 60, thereby biasing the bung upwards.

The bung 56 has a rod 62 attached to the upper end thereof. A (downwardly facing) valve seat 64 spans the chamber 54. The seat 64 is concave shape to correspond to the upper end of the bung 56 and has appropriate opening therein to allow rod 62 to protrude therethrough.

At the upper end of the rod 62 is a rubber seal 66 and a piston 68.

Above the piston 68, the chamber 54 is in fluid communication with a region sealed by a heat sensitive sealing element such a liquid filled glass bulb (not shown). Pressurised air in chamber can condense into liquid which can cause corrosion of chamber. In the invention, the region housing the piston is filled with grease.

Ordinarily, the valve assembly is in an open configuration. Pressurised air in the region above the piston pushes the bung down against the spring. Fluid flows from a first part 70 of a conduit into a second part 72 of the conduit, which parts 70 and 72 are in line.

Referring to FIG. 3, if the liquid filled glass bulb breaks, the region above the piston 68 de-pressurises, and, under the force of the spring 58, rubber bung 56 will move upwardly to the seat 64.

Referring to FIG. 4, when the bung 56 is against the seat 64 no fluid can flow through the valve from the first part 70 of the conduit into the second part 72 of the conduit.

It will be appreciated that the valve assembly 50 is cross-shaped. However, the first part and second part of the first conduit may be offset from one another to cater for a difference in height of co-operating pipe work. Alternatively, the first part and second part may be made from flexible parts.

Referring to FIG. 5, a valve assembly 80 has a chamber again in fluid communication with a region sealed by a heat sensitive sealing element such a liquid-filled glass bulb 82.

In this embodiment, a seat 84 is arranged to face upwardly. A sealing end 86 of the bung 87 is lowermost. A piston 88 and washer 90 are arranged respectively behind the trailing edge of the bung.

A rod 91 extends from the foremost end of the bung downwardly. The other end of the rod has a plate 92. A compressed spring 94 is arranged below the plate 92.

When the bulb 82 bursts, the upper region de-pressurises, and the bung 87 moves away from the seat 84 under the force of the spring 94. Once the bung 87 moves away from the seat 84 the pipeline is opened.

Instead of the bulb of the above embodiments, the region above the piston could be sealed by any fusible, e.g. low melting point, cap.

Referring to FIG. 6, a valve assembly 100 can be moulded e.g. from plastics material. The valve assembly 100 is made in the shape of a shield. The assembly 100 comprises a chamber 102. The upper and lower ends of the chamber have female threads, which each receive male threads of top and bottom caps 103, 104. The cap(s) 103, 104 can be made from an insulating material such as PVC. Seals 105 are arranged at both connections. The valve assembly 100 is in fluid communication with a pressurised region either through, or by replacement of, the upper cap 104.

A first conduit 106 and a second conduit 108 extend in a branch like manner from the chamber 102. The free ends of the first conduit 106 and a second conduit 108 each have male threads, which connect to pipe work (not shown for conciseness).

Referring to FIG. 6, the valve assembly has two mounting points 110, 112. Referring to FIG. 7, through which screws 114 or suitable fasteners can be fitted.

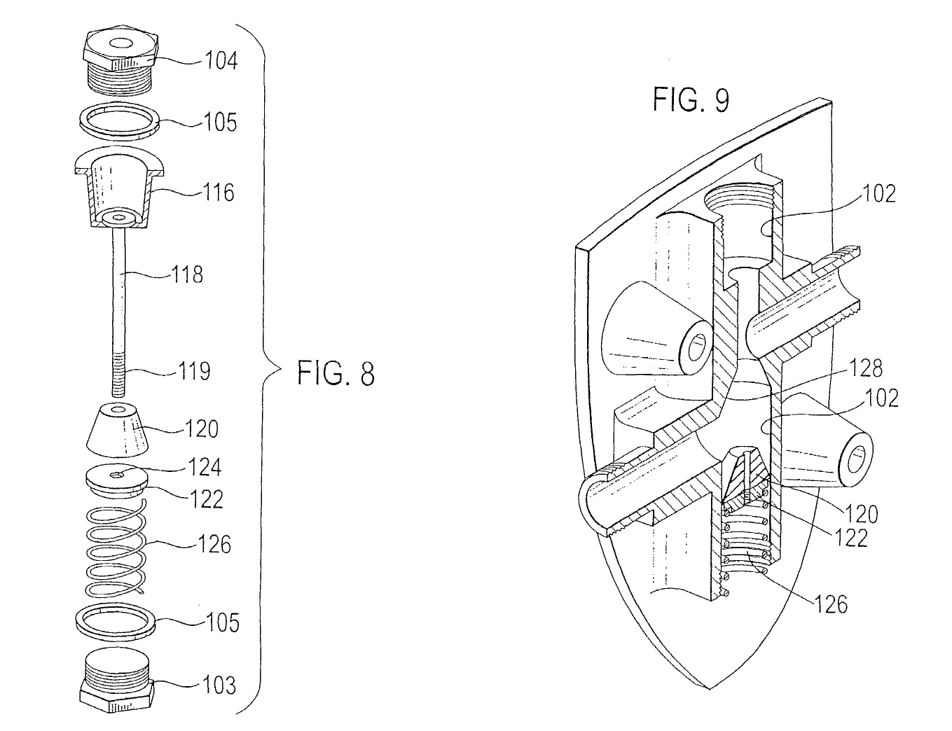

Referring to FIG. 8, the internal components comprise bellows 116, piston 118 with screw thread 119, rubber bung 120, spring locator 122 with screw thread 124, and spring 126.

The components are arranged inside the chamber 102 as set out in FIG. 9. In particular, the bellows 116 sit above the seat 128 and the rubber bung 120 sits below the seat, the rod passing through the seat.

Referring to FIG. 10, there is a manually actuable version of the valve assembly. A housing 130 has a lever 131 hingeably fitted thereto. The lever has a protrusion 132 extending therefrom. The housing has a slot 133 in which the protrusion locates. At the base of the slot 133 is a bore 134 which passes through the housing. A piston 135 passes through the centre of an upper closure cap, and is attached to the lever 131. When the lever 131 is moved the piston and valve move. A removable pin 137 locates in the bore in the lower end of the protrusion 132 and the bore 134 in the housing 130 to keep the valve open. A person such as an elderly person can pull out the pin, letting the lever move under the force of a spring, to close the valve.

Referring to FIG. 11, a valve assembly, whilst operationally similar to the assembly of FIGS. 8 and 9, can be cast from aluminium in a more conventional shape, and can have strengthening webs 150 at the junctions of the chamber and the pipe parts.

Referring to FIG. 12, the valve assembly is planar.

Referring to FIGS. 13, 14 and 15, the valve assembly has a cap 152 with a recess for a screw driver, a piston 154 and having a lower bung 156, and a sealing ring 158 which sits on the rearmost end of the bung. Its operation under the spring 160 is shown in FIG. 11.

Valve assembly can be arranged adjacent a domestic boiler in an airing cupboard.

Referring to FIG. 21, a valve assembly 200 is cross-shaped. A first conduit 202 and a second conduit 209 meet at third conduit 201.

In the third conduit 201 is a valve seat 213. A rod 205 has a seal 206 and piston 207 at its upper end and a plunger 203 and a connector 204 for connecting the plunger to the rod. The rod 205 carries a magnet at its lower end. A cap 215 is arranged in lower end of the third conduit 201. Rod 205 is arranged in third region 201. A spring 202 is arranged between plunger 203 and cap 215. seal 206 and piston 207 sit above seat 213. A region 211 above the piston 207 is then pressurised to push the spring down and open the valve.

A feed pipe 208 connects second conduit 209 and third conduit. Alternatively/additionally a feed pipe can connect first conduit 202 and third conduit as shown in dotted line. feed pipe 208 is arranged concentrically inside (or outside in another embodiment) of the second conduit 209. feed pipe 208 continues concentrically inside (or outside in another embodiment) of a fourth conduit 210 of the first conduit, which can be carrying fuel or water, and is filled with pressurised fluid in fluid communication with the second conduit 11 and at same pressure. When the valve assembly is in an open configuration, as shown, fluid flows from the first conduit 202 into the second conduit 209. If the feed pipe 8 breaks the valve closes down. The internal pressure will be lost and the spring 2 will cause the rubber bung to move upwardly. Top of plunger 3 can taper in a straight line rather than having a convex leading edge.

In the event of pressure loss, the magnet 12 fitted to the base of the rod 5 will move away from a reed connector arranged beneath the valve (not shown for conciseness) thereby breaking an electrical contact, e.g. to the electric appliance. It can also initiate a current e.g. to start a fan or an alarm. can cause an alarm to be activated etc.

When a boat is moored and unattended for a long time there can be a build up of dangerous gases. It is useful to be able to detect them. A boat can comprise one or more of the valve assemblies described herein.

The valve assembly 200 can be arranged in a boat fuel supply line. The valve assembly will close down the fuel supply in the event of sensing CO2, or gas by CO2 detector 402a, gas detector 402b. The electricity supply is also stopped so as to prevent ignition. Because of its low power consumption, i.e. a 12 v battery, a similar device to this device can be fitted in a mobile home.

Control means (not shown for conciseness) then re-pressurises the valve assembly 200 and will then enable fuel to pass through pipes after detection is rectified.

The relay valve can be used to open and close fuel or other fluid supply lines.

The batteries can be removed from a conventional smoke alarm. Instead, a smoke alarm can be hard wired to the relay valve, and be solar powered.

The Applicant has also invented a telemetry based valve assembly for remote and wireless control of fluid flowing through a water, or other fluid supply line.

Referring to FIGS. 22, 23 and 24, a valve assembly for a water supply line comprises a cast valve assembly housing 300. The valve housing 300 has pipe parts 302 and 304 and defines a valve cavity 306 therebetween. A rod 308 has a ball 310 attached to it. The rod is arranged so that it can rotate about its axis and move the ball to and from a valve seat 312. In accordance with the invention, the cavity 306 is recessed to accommodate the ball 310 such that in one configuration the ball 310 does not impede the flow of fluid through the pipes. The ball valve can be replaced by a gate valve. The rod 308 extends out of housing 300 through a control box attachment plate 314.

Referring to FIG. 25, a telemetry unit 320, comprising known telemetry equipment, defines an aperture 322 for sliding the unit onto a pipe. The unit 320 has a U shaped plate 324 attached to it by fastening means 326, a lower face of which is arranged to cooperate with control box attachment plate 314.

The unit 320 is installed on the housing 300 as shown in FIG. 26. A U shaped hood 328 is then attached to the U shaped plate 324 (of the unit 320) to make a cube-like enclosure 330 for the working parts unit 320. The U shaped hood 328 has fastening means to fasten the hood to the housing 300.

Referring to FIGS. 27 and 28, as mentioned above the rod 308 protrudes through the lower face of the U shaped plate 324

The rod 38 is attached to a 60:1 gearing 301 (i.e. 60 spins of motor for one revolution), that being ample to open and close a valve of this type. The gearing 301 is driven by a (reversible) electric motor 302, by way of a rubber wheel or cog 303 (drive belt optional). The motor is 1.5 Volts and is powered by a 1.5 Volts battery. The motor could be replaced by a variable powered motor, e.g. 12 v variable to 1.5 v. Variable power allows variable speed of valve. The assembly has a receiver 306 for receiving radio or microwave signals.

Referring to FIG. 29, the receiver 306 is arranged to be activated by a mobile telephone 309. Alternatively the motor may be activated by a radiometer 320 which can sense microwave signal or the like.

In use, the receiver 306 activates a relay (not shown for conciseness), which in turn activates a switch (not shown for conciseness), which in turn activates motor 302. The signal can be used to open or close the valve.

The receiver can comprise a mobile phone. The speaker of the mobile phone will emit a noise when a call is received. The speaker will emit a sound which can be used to activate a relay or other control. The receiver can have a first telephone number which can be contacted to open the valve and a second telephone number which can be contacted to close the valve.

Since valve is powered by only about 1.5 volts, the valve is fairly slow moving. Such slow movement of the valve avoids water hammer effect.

When the valve moves to a closed position the cog builds up back-pressure, which signals the motor to stop the closing action, thereby stopping damage t the valve.

The device 304 can be fitted to a water meter 307, with reading interface 308, as shown in FIG. 29 to provide a combination of reading and control. Alternatively the device can be fitted to a gas or fuel meter.

Referring to FIG. 30, a pipe has a hole (not shown) in its wall. Through the hole runs a shaft 402, the shaft being attached to a motor 404. The shaft has a paddle on one end, arranged in such a way that the paddle will rotate in the flow. The paddle can be recessed into a wall of the pipe so that the shaft is tangential to the pipe wall. Flow in the pipe will turn the paddle which will induce a current, which can be used to power e.g. the relay of the control calve assembly of the invention.

The valve assemblies hereinabove can be coupled with excess flow sensors to provide a more comprehensive safety system.

1-36. (canceled)

37. A valve assembly for a fluid line, wherein the valve assembly comprises a first region for a first pressurised fluid, a second region for a second pressurised fluid, and a valve between the first and second regions, a receiver unit for receiving a remote, wireless, signal, and a motor driven ball or gate valve which, upon receipt of the remote, wireless, signal, is powered to operate the valve between the first and second regions.

38. A valve assembly according to claim 37, wherein the valve assembly is installed on a water supply line.

39. A valve assembly according to claim 37, wherein the ball or gate valve is driven by a geared motor.

40. A valve assembly according to claim 39, wherein the gearing ratio is more than 10:1.

41. A valve assembly according to claim 39, wherein the gear ratio is more than 50:1.

42. A valve assembly according to claim 39, wherein the gearing ratio is about 60:1.

43. A valve assembly according to claim 37, wherein the ball or gate valve is driven by a variable powered motor.

44. A valve assembly according to claim 37, wherein the valve housing defining the first region and second region is moulded or cast.

45. A valve assembly according to claim 37, wherein a telemetry unit is fitted to the valve assembly.

46. A valve assembly according to claim 45, wherein the unit defines an aperture which allows the unit to be slid onto a pipe.

47. A valve assembly according to claim 37, wherein the valve assembly is arranged on a vehicle such as a mobile home or sea craft such as a boat.

48. A high pressure fluid line comprising a valve assembly, the valve assembly comprising a housing and a ball or gate valve, the housing defining a recess, wherein when the ball or gate valve is actuated the ball or gate valve moves into the recess and substantially out of the flow path of fluid in the line.

49. A valve assembly for a fluid line, wherein the valve assembly comprises a biometrics recognition unit such as a fingerprint recognition unit to prevent tampering.

50. A valve assembly according to claim 37, wherein the valve assembly comprises a suction unit which can trap a hand of a person so as to prevent tampering.

51. A safety valve assembly comprising a first region for a first pressurised fluid, the region having a first outlet, a second region for a second pressurised fluid, a valve between the first and second regions, wherein the safety valve assembly is remotely, wirelessly, electronically operable, and the valve assembly is arranged to be at least partially powered by flow through the valve.

52. A safety valve assembly according to claim 51, wherein the valve assembly is installed on a water or fuel supply line.
